(19) United States
(12) Patent Application Publication
(10) Pub. No.: US 2008/0039077 A1
(43) Pub. Date: Feb. 14, 2008

(54) Method for a Mobile Station to Roam Among Networks of Different Criteria

(75) Inventors: Yang Yang, Guangdong Province (CN); Xiaolan Tang, Guangdong Province (CN)

Correspondence Address: WALKER & JOCKE, L.P.A., 231 SOUTH BROADWAY STREET, MEDINA, OH, 44256, US

(73) Assignee: ZTE CORPORATION, Shenzhen, Guangdong (CN)

(21) Appl. No.: 11/571,697

(22) PCT Filed: Jul. 6, 2004
(86) PCT No.: PCT/CN04/00759

§ 371 Date: Jan. 5, 2007

(51) Int. Cl. H04Q 7/20

(52) U.S. Cl. 455/432.1

(57) ABSTRACT

The present invention provides a method for a mobile station to roam among networks of different criteria. It includes: recording user information in number portability database, when a mobile station processes location registration, the home location register of the current roaming network processes an inter-network number portability request, then returns a location register response message; when the mobile station initiates a call, the call flow is the same as the current initiation flow; when the mobile station ends a call, the initiation switch center obtains the inter-network roaming state of the mobile station, then processes call transfer. The present invention expediently realizes inter-network roaming among networks of different criteria, especially the inter-network roaming between the GSM network and the CDMA network, need not realize complicated IIF protocol conversion function, reduces infection to the current network stability, and realizes number portability when the subscriber roams among different networks; it uses a simple private interface between the number portability database and the home location register, does not depend on the standards of GSM MAP and CDMA MAP and does not infect the absolute development of the two networks.

### FIELD OF THE INVENTION

The present invention relates to an interconnection and intercommunication technology among mobile communication networks of different criteria, and specifically, to a method for a mobile station to roam between the GSM network and CDMA network.

### BACKGROUND OF THE INVENTION

In the field of mobile communication, the GSM network and CDMA network are two representative networks based on different technological standards, the developments of the two networks are separated from each other, but interconnection and intercommunication among networks of different criteria is desired more and more, accordingly, the interconnection and intercommunication technology among networks of different criteria is developed.

An representative interconnection and intercommunication technology is a network interconnection technology based on an Interworking and Interoperability Function (short for IIF) entity, which is proposed by 3GPP2 (3^{rd} Generation Partnership Project 2) Organization. By introducing the IIF entity, the technology implements the protocol conversion between GSM Mobile Application Part (short for MAP) and CDMA MAP, thereby combining the GSM network and CDMA network. As for a GSM subscriber who roams to the CDMA network, the IIF entity acts as a HLR (Home Location Register) in the CDMA network and a VLR (Visited Location Register) in the GSM network for the subscriber; and as for a CDMA subscriber who roams to the GSM network, the IIF entity acts as the HLR in the GSM network and the VLR in the CDMA network for the subscriber.

Another interconnection and intercommunication technology adopts the solution of mobile service node (short for MSN), and in this solution, MSN is used as a connecting device between the CDMA wireless access network and the GSM core network. As for a GSM subscriber who roams to the CDMA network, MSN acts as the MSC (Mobile Switching Center) in the GSM network, and shields the CDMA wireless access network, therefore, implements the conversion between the CDMA1x IOS (Interoperability Specification) protocol and the GSM MAP protocol.

Comparison is made between the above two technical solutions and it can be seen that the network interconnection technology based on IIF entity does not need the existing GSM network and CDMA network to provide a new protocol support, the IIF entity bridges the communication between the CDMA core network and GSM core network, and shields the infection of inter-network roaming to a home network; on the other hand, the solution based on MSN needs to change the existing network a lot. In addition, both of the above two technical solutions are required to be compatible for the protocol and standard of the two networks, the IIF entity should complete complex protocol conversion, and the MSN also needs to provide protocol support for a heterogeneous network, then it is relatively complex to carry out the above two solutions.

Besides the above two solutions, Chinese patent application No. 02104295.0, entitled “A Method for Implementing Signaling Intercommunication Between the GSM network and CDMA network” also provides a mechanism for solving the interconnection and intercommunication between networks. In the method, a communication interface between the HLR in the GSM network and the HLR in the CDMA network is established first, and the inter-network roaming of a user is supported through the interaction of inner message between the GSM HLR and CDMA HLR. A mobile user who supports double modes keeps a piece of subscriber data at the GSM HLR and CDMA HLR respectively, and the mobile user numbers in the two pieces of subscriber data serve as a forwarding number for each other. In the process of location registration, a procedure of sending the roaming state of the current network where the user resides to the non-current network is added; and in the flow of obtaining called location information, a step of judging the current network where the user resides is added. Then the HLR determines, according to the roaming state of the user, to return a normal routing number or a mobile user number of the opposite network recorded in a forwarding number field. It is not necessary for this solution to add in existing networks a IIF entity which performs complex translation function, and is easy to implement, however, the mobile user needs to use different numbers in the GSM network and the CDMA network respectively, such that Number Portability (Number Portability, short for NP) as the user roams among networks cannot be implemented, and besides, the forwarding property of the user is also influenced.

NP is a technology for a user to go on use an original number after the user changes a service provider, wherein the Number Portability Database (short for NPDB) is a key entity for implementing NP function, and is used for recording the corresponding relation between the directory number of the user and the location routing number of a service network. When the user changes the service provider, the location routing number recorded in the NPDB should be amended, too. When a call enters an ingress switch, the ingress switch sends search information to the NPDB for searching the location routing number; the NPDB returns the location routing number in the new service network of the called user to the ingress switch, and guides the ingress switch to connect the call to the current service network of the called user. NP technology is developed from fixed switch network, and currently, its application has expanded to the mobile switching field, but the technology is generally used for PN among different service providers in the networks of the same criterion. US patent application No. 20020052211, entitled “Method for Providing Number Portability of Mobile Phone”, proposes a NP solution that a NPDB which supports multiple network search interfaces is used in networks of different criteria. In this method, the NPDB supports the search request initiated by networks of multiple criteria, and can return the location routing number of the current service network of the called user to the switches of the networks of multiple criteria, thereby supporting the carrying of the number by the user to networks of different criteria. However, the NPDB of the invention does not have the capability of managing inter-network roaming of the mobile station.

### SUMMARY OF THE INVENTION

The technical problem the present invention aims to solve is to provide a method for a mobile station to roams among networks of different criteria, so as to solve the problem of interconnection and intercommunication among networks of different criteria, especially among the GSM network and CDMA network, and meanwhile, to implement NP when the user roams among different networks.

The method for a mobile station to roams among networks of different criteria according to the present invention comprises:

record user information in NPDB, wherein the user information includes a directory number and a location routing number of the mobile station, a mobile station identifier that the mobile station signs at network 1, a mobile station identifier that the mobile station signs at network 2, and current NP state of the mobile station;

when the mobile station conducts location registration, the HLR of the current roaming network conducts an inter-network NP request operation, then returns a location registration response message;

when the mobile station initiates a call, the call flow is the same as the current initiation flow;

when the mobile station ends the call, the initiation switching center obtains the inter-network roaming state of the mobile station, and then conducts a call connection operation.

In the present invention, the flow that the mobile station conducts location registration specifically comprises:

step 1, the switching center of the current roaming network initiates a location registration request to the HLR of the present network after receiving the location registration request initiated by the mobile station;

step 2, the HLR of the current roaming network sends an inter-network NP request message to the NPDB;

step 3, the NPDB judges whether it is necessary to notify the original roaming network of the mobile station to logout the registration; and if not necessary, the flow proceeds to step 5;

step 4, if it is necessary to notify the original roaming network of the mobile station, the NPDB sends an inter-network NP logout request message to the HLR of the original roaming network, then the HLR in turn sends a logout registration message to the switching center of the original roaming network; after receiving the logout registration response message returned by the switching center of the original roaming network, the HLR of the original roaming network returns an inter-network NP logout response message to the NPDB;

step 5, the NPDB records the current NP state of the mobile station, and sends an inter-network NP response message to the HLR of the current roaming network of the mobile station; and

step 6, the HLR of the current roaming network returns a location registration response message to the switching center of the present network.

The procedure that the mobile station ends the call specifically comprises: after receiving the call request, the initiation switching center queries the NPDB for the location routing number of the called user; the NPDB returns the location routing number to the initiation switching center, and the initiation switching center completes the call connection according to the location routing number.

The procedure that the mobile station ends the call further comprises: after receiving the call request, the initiation switching center checks whether the called user is a potential NP user; if not, process as a normal call flow; and if the user is a potential NP user, the subsequent steps are executed

The initiation switching center judges whether the user is a potential NP user according to the directory number of the mobile station, which is specifically as follows: if the directory number of the mobile station is within the range of a set inter-network roaming user number, then the user is considered as the potential NP user, or else, the user is not the potential NP user.

Through functional expansion of and simple amendment to the NPDB, switching center, and HLR of the existing network, the present invention realizes inter-network roaming among the networks of different criteria expediently, especially inter-network roaming between the GSM network and CDMA network; it is not required for the present invention to realize complicated IIF protocol conversion function, thus reduces infection to the stability of the current network, and meanwhile, realizes NP in case of inter-network roaming. Moreover, it uses a simple private interface between the NPDB and HLR, which does not relay on the standards of GSM MAP and CDMA MAP, as a result, it will not infect the absolute development of the two networks.

### BRIEF DESCRIPTION OF THE DRAWINGS

FIG. 1 is a schematic view of the structure of the network used in the method according to the present invention;

FIG. 2 is a flowchart of the location registration conducted by the mobile station of the method according to the present invention

FIG. 3 is a flowchart shows that the mobile station is called when roaming in the present network of the method according to the present invention; and

FIG. 4 is a flowchart shows that the mobile station is called when roaming among different networks of the method according to the present invention.

### EMBODIMENTS FOR CARRYING OUT THE PRESENT INVENTION

Hereinafter, the present invention will be described in detail with reference to the drawings and embodiments thereof.

The method according to the present invention is used for inter-network roaming among networks of different criteria. In the following embodiment, network 1 is the GSM network, network 2 is the CDMA network, and the mobile station is one that supports networks of different criteria. As shown in FIG. 1, the switching center, i.e. MSC/VLR, as well as the HLR in the GSM network and the CDMA network respectively connect to the NPDB, wherein the signaling interface between the HLR and the NPDB is newly added, and the GSM network and the CDMA network are connected through their respective gateway office GMSC. In the network, the HLR further cooperates with the NPDB to realize inter-network NP management of a double module mobile user in addition to complete its basic functions in respective networks, comprising: adding a process of initiate a NP request signaling to the NPDB during the location registration procedure of the mobile station, adding a process of sent an inter-network NP deactive signaling to the NPDB during the power off procedure of the mobile station, and adding a process of initiate an inter-network NP cancel signaling to the NPDB. The NPDB mainly realizes the management over user inter-network NP, comprising: responding to the inter-network NP request signaling and inter-network NP deactive signaling initiated by the HLR of the current roaming network of the mobile station, and initiating inter-network NP cancel signaling to the HLR of the original roaming network. In addition, the MSC should support NP function, and can search the NPDB for the location routing number.

Before inter-network roaming, the double module mobile user needs to sign a piece of user information with the GSM network and the CDMA network respectively, and in the two networks, directory numbers of the user are the same. Thereafter, the user information is recorded and stored in the NPDB, including the directory number of the mobile station, the location routing number, the mobile station identifier of the mobile station signed at the GSM network, the mobile station identifier of the mobile station signed at the CDMA network, and current NP state of the mobile station, wherein the location routing number is the routing number of the gateway office of the GSM network or the CDMA network; and the NP state comprises the roaming network and active state of the mobile station.

The method for realizing inter-network roaming according to the present invention comprises: the location registration flow of the mobile station, the power off flow of the mobile station, the initiation flow of the mobile station, and the call ending flow of the mobile station.

When the mobile station conducts location registration, for a double network roaming user, the HLR of the current roaming network adds a process of initiate a inter-network NP request to the NPDB, if the NP of the mobile station in the heterogeneous network recorded in the NPDB is in an active state, then an inter-network NP cancel message is sent to the original roaming network; after receiving the inter-network NP cancel message, the HLR of the original roaming network sends a logout registration message to the MSC/VLR of the original roaming network of the mobile station, indicating the user has left.

When the mobile station powers off, the HLR of the current roaming network sends a inter-network NP deactive message to the NPDB, and the NPDB updates the NP of the mobile station in the network as the deactive state.

The initiation flow of the mobile station is the same as the existing one.

When the mobile station ends the call, the initiation MSC searches the NPDB for the location routing number, and thus obtains the inter-network roaming state of the mobile station. If the current roaming network of the mobile station is the same as that of the caller, the initiation MSC requests the HLR of the present network for a roaming number, and completes the call connection; otherwise, the initiation MSC connects the call to the gateway office GMSC of the current roaming network of the mobile station according to the location routing number returned by the NPDB, then the gateway office of the roaming network continues to request the HLR of the roaming network for the roaming number, and completes the call connection of the mobile station after its inter-network roaming.

Before searching the location routing number, the initiation MSC can judge whether the called user is a potential NP user first, which is specifically as follows: if the directory number of the called user is within the range of a set inter-network roaming user number, then it is considered that the user is a potential NP user, or else, it is not a potential NP user. If the user is not a potential NP user, then process as a normal call ending flow; and if it is a potential NP user, process the searching of the location routing number.

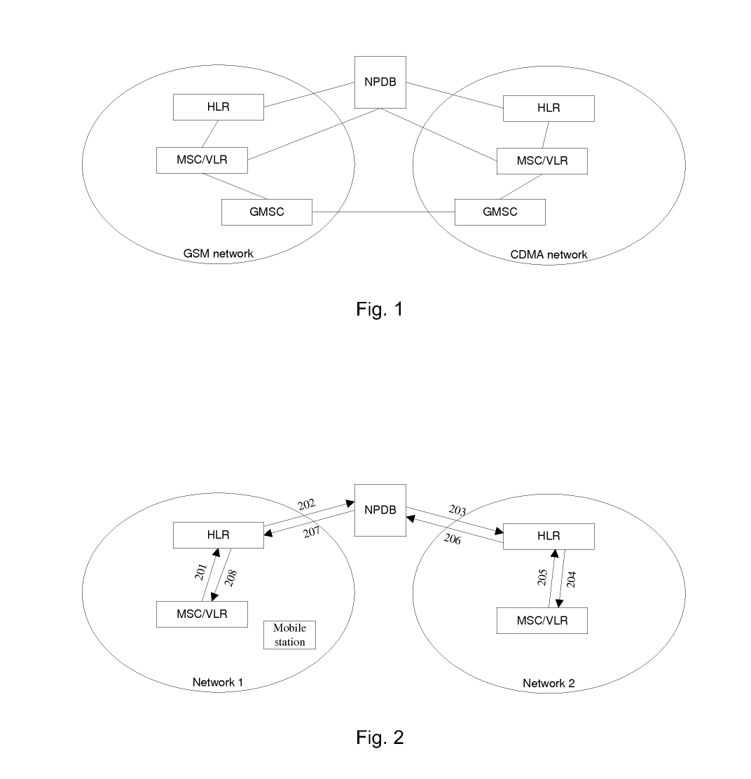

The above mentioned flow is described hereinafter in detail with reference to FIGS. 2-4.

FIG. 2 shows the procedure of a location registration conducted by the mobile station. The MSC/VLR of the current roaming network of the double module mobile station initiates a location registration request message to the HLR of the present network (step 201), and the HLR sends the inter-network NP request message to the NPDB after receiving the location registration request message (step 202). The NPDB determines whether to notify the original roaming network to logout the registration according to the recorded current power on/off state of the mobile station and the roaming network, if it is recorded in the NPDB that the mobile station is in a power off state or the recorded roaming network is the network that currently sends the inter-network NP request, then the procedure jumps to step 207; otherwise, the NPDB sends an inter-network NP logout request message to the HLR of the original roaming network of the mobile station, and notifies that the user has roamed to other networks (step 203). The HLR of the original roaming network sends the logout registration message to the MSC/VLR of the original roaming network (step 204), after logouts the mobile station, the MSC/VLR of the original roaming network returns a logout registration response message to the HLR of the original roaming network (step 205). The HLR of the original roaming network returns an inter-network NP logout response message to the NPDB (step 206), then the NPDB records the current roaming network and active state of the mobile station, and sends the inter-network NP response message to the HLR of the current roaming network (step 207), and the HLR of the current roaming network sends a location registration response message to the MSC/VLR of the current roaming network of the mobile station, thus completes the location registration of the mobile station (step 208).

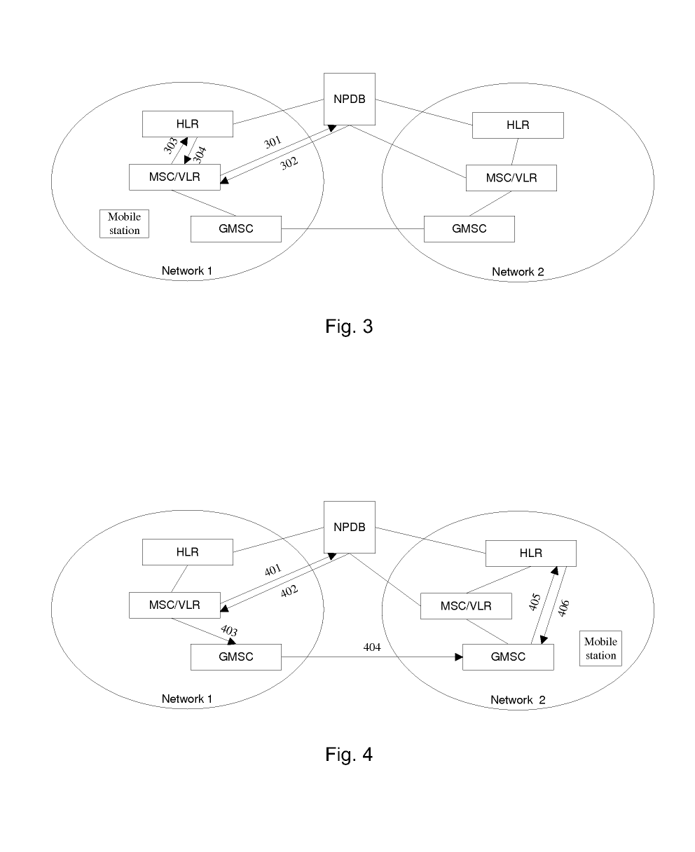

FIG. 3 is a flowchart shows that the mobile station is called when roaming in the present network of the method according to the present invention. The initiation MSC/VLR sends a call request, the called user is a double module mobile station user, and the MSC/VLR searches the NPDB for the location routing number (step 301). The NPDB returns the location routing number to the initiation MSC/VLR according to the current roaming network of the mobile station. In FIG. 3, in the case where the current roaming network of the mobile station recorded in the NPDB is the network that currently initiates the search request, the NPDB will return an empty response, and indicates the initiation MSC/VLR that the called user is in the present network (step 302). The initiation MSC/VLR initiates a location search to the HLR of the present network (step 303), and the HLR of the present network completes the transfer between a called routing number and a temporary local number, then the initiation MSC/VLR connects the call to the mobile station (step 304).

As shown in FIG. 4, in the flow that the mobile station is called when roaming among different networks, first, the initiation MSC/VLR initiates a call request, the called user is a double module mobile station user, the initiation MSC/VLR searches the NPDB for the location routing number (step 401). The NPDB returns the location routing number to the initiation MSC/VLR according to the current roaming network of the mobile station. In FIG. 4, the current roaming network of the mobile station recorded in the NPDB and the MSC/VLR that currently initiates the search are not within the same network, and the NPDB returns the location routing number of the gateway office of the current roaming network of the mobile station according to the location of the caller (step 402). The initiation MSC/VLR connects the call to gateway office of the present network upon knowing that the mobile station is not in the present network. If the call adopts ISUP signaling, then the directory number of the called user will be carried in parameter Generic Address, and the address type is indicated as portable number, while the location routing number returned by the NPDB is carried in parameter Called Party Number (step 403). The gateway office of the present network connects the call to the gateway office of the current roaming network of the mobile station (step 404), and the gateway office of the current roaming network initiates a location search to the HLR of the current roaming network, thus the HLR completes the transfer between the called user routing number and the temporary local number (step 405). The HLR returns a response message, and the gateway office of the roaming network connects the call to the double module mobile station (step 406).

The method according to the present invention can not only be used for the inter-network roaming between the GSM and CDMA, which of two criteria, but also can be used in mobile networks of other criteria. In case of the support of the mobile terminal, the present invention can realize double networks roaming or multiple networks roaming of multiple criteria networks.

While the present invention has been particularly shown and described with reference to the embodiments thereof, it will be understood by those skilled in the art that any amendment or equivalent replacement made to the technical solution of the present invention without departing from the spirit and scope of the present invention shall all be covered by the scope of the claims of the present invention.

What is claimed is:

1. A method for a mobile station to roam among networks of different criteria, characterized in comprising:
record user information in NPDB, wherein the user information includes a directory number and a location routing number of a mobile station, a mobile station identifier of the mobile station that the mobile station signs at network 1, a mobile station identifier of the mobile station that the mobile station signs at network 2, and the current NP state of the mobile station;
when the mobile station conducts location registration, the HLR of the current roaming network conducts an inter-network NP request operation, then returns a location registration response message;
when the mobile station initiates a call, the call flow is the same as the current initiation flow; and
when the mobile station ends the call, the initiation switching center obtains the inter-network roaming state of the mobile station, and then conducts a call connection operation.

2. The method for a mobile station to roam among networks of different criteria according to claim 1, characterized in that the flow that the mobile station conducts location registration specifically comprises:
step 1, the switching center of the current roaming network initiates a location registration request to the HLR of the present network after receiving the location registration request initiated by the mobile station;
step 2, the HLR of the current roaming network sends an inter-network NP request message to the NPDB;
step 3, the NPDB judges whether it is necessary to notify the original roaming network of the mobile station to conduct logout registration; and if not necessary, the flow proceeds to step 5;
step 4, if it is necessary to notify the original roaming network of the mobile station, the NPDB sends an inter-network NP logout request message to the HLR of the original roaming network, then the HLR in turn sends a logout registration message to the switching center of the original roaming network; after receiving the logout registration response message returned by the switching center of the original roaming network, the HLR of the original roaming network returns an inter-network NP logout response message to the NPDB;
step 5, the NPDB records the current NP state of the mobile station, and sends an inter-network NP response message to the HLR of the current roaming network of the mobile station; and
step 6, the HLR of the current roaming network returns a location registration response message to the switching center of the present network.

3. The method for a mobile station to roam among networks of different criteria according to claim 2, characterized in that the step that the NPDB judges whether it is necessary to notify the original roaming network of the mobile station to logout the registration in the step 3 further comprises: the NPDB determines whether to notify the original roaming network to logout the registration according to the recorded current power on/off state of the mobile station and the roaming network, in the case where the mobile station recorded in the NPDB is in a power off state or the recorded roaming network is the network that currently sends the inter-network NP request message, it is not necessary to notify the original roaming network to logout the registration; and in the case where the mobile station recorded in the NPDB is in a power on state and the recorded roaming network is not the network that currently sends the inter-network NP request message, it is necessary to notify the original roaming network to logout the registration.

4. The method for a mobile station to roam among networks of different criteria according to claim 1, characterized in that the procedure that the mobile station ends the call specifically comprises: after receiving the call request, the initiation switching center checks whether the called user is a potential NP user; and if the user is not a potential NP user,then process as a normal call ending flow; if the user is a potential NP user, then the initiation switching center searches the NPDB for the location routing number; the NPDB returns the location routing number to the initiation switching center, and the initiation switching center completes the call connection according to the location routing number.

5. The method for a mobile station to roam among networks of different criteria according to claim 4, characterized in further comprising: the initiation switching center checks whether the called user is a potential NP user first after receiving the call request; and if the user is not a potential NP user, then process as a normal call ending flow; if the user is a potential NP user, the subsequent steps will be processed.

6. The method for a mobile station to roam among networks of different criteria according to claim 5, characterized in that the initiation switching center judges whether the user is a potential NP user according to the directory number of the mobile station, which is specifically as follows: if the directory number of the mobile station is within the range of a set inter-network roaming user number, then the user is considered as a potential NP user, or else, the user is not a potential NP subscriber.

7. The method for a mobile station to roam among networks of different criteria according to any of claims 4-6, characterized in that the step that the initiation switching center completes the call connection according to the location routing number further comprises: in the case where the location routing number is empty, it indicates that the mobile station and the initiation switching center are in the same network, the initiation switching center initiates a location search to the HLR of the present network, and the HLR of the present network completes the transfer between a called routing number and a temporary local number, then the initiation switching center connects the call to the mobile station; in the case where the location routing number is not empty, it indicates that the mobile station and the initiation switching center are not in the same network, and the location routing number is the location routing number of the gateway office of the current roaming network of the mobile station, the initiation switching center connects the call to the gateway office of the current roaming network of the mobile station through the gateway office of the present network upon knowing that the mobile station is not in the present network, and the gateway office of the current roaming network initiates a location search to the HLR of the current roaming network, the HLR completes the transfer between the called routing number and the temporary local number and returns a location response message, then the roaming network gateway office connects the call to the mobile station.

8. The method for a mobile station to roam among networks of different criteria according to claim 7, characterized in that when the initiation switching center connects the call to the gateway office of the current roaming network of the mobile station through the gateway office of the present network, if the call adopts ISUP signaling, then the directory number of the called user is carried in parameter Generic Address, and the address type is indicated as a portable number, while the location routing number returned by the NPDB is carried in parameter Called Party Number.

9. The method for a mobile station to roam among networks of different criteria according to claim 1, characterized in further comprising: when the mobile station powers off, the HLR of the current roaming network of the mobile station sends an inter-network NP deactive message to the NPDB, and the NPDB updates the NP of the mobile station in the network as the deactive state.

10. The method for a mobile station to roam among networks of different criteria according to claim 1, characterized in that the network 1 is the GSM network, and the network 2 is the CDMA network.

11. The method for a mobile station to roam among networks of different criteria according to claim 1, characterized in that the directory number of the mobile station in networks of different criteria is the same.

12. The method for a mobile station to roam among networks of different criteria according to claim 1, characterized in that the NP state of the mobile station comprises the roaming network and the activate state of the mobile station.
